(19) United States
(12) Patent Application Publication
(10) Pub. No.: US 2014/0345325 A1
(43) Pub. Date: Nov. 27, 2014

(54) DOUBLE ION EXCHANGE PROCESS

(71) Applicant: Corning Incorporated, Corning, NY (US)

(72) Inventors: Douglas Clippinger Allan, Corning, NY (US); Sumalee Likitvanichkul, Painted Post, NY (US); Mehmet Derya Tetiker, San Francisco, CA (US)

(73) Assignee: Corning Incorporated, Corning, NY (US)

(21) Appl. No.: 14/280,741

(22) Filed: May 19, 2014

Related U.S. Application Data
(60) Provisional application No. 61/827,186, filed on May 24, 2013.

(51) Int. Cl. C03C 21/00

(52) U.S. Cl. CPC C03C 21/002
USPC 65/30.14

(57) ABSTRACT

A method for optimizing ion exchange of glass. The glass is ion exchanged in a series of two ion exchange baths. The first ion exchange bath contains an amount of a poisoning ion or salt and the second ion exchange bath contains an amount of the poisoning ion or salt that is less than that in the first bath. When the concentration of the poisoning ion/salt in the first bath reaches a maximum value, the first bath is discarded and replaced by the second bath and a third bath that initially does not contain the poisoning cation/salt replaces the second ion exchange bath. This cycling of baths may be repeated to produce a plurality of glass articles, each having a surface layer under a compressive stress and depth of layer that are within predetermined limits.

This application claims the benefit of priority under 35 U.S.C. §119 of U.S. Provisional Application Ser. No. 61/827,186, filed on May 24, 2013, the content of which is relied upon and incorporated herein by reference in its entirety.

### BACKGROUND

The disclosure relates to chemical strengthening of glasses. More particularly, the disclosure relates to chemical strengthening of glasses by ion exchange processes. Even more particularly, the disclosure relates to chemical strengthening of glasses by multiple ion exchange processes conducted in series.

Ion-exchange processes are used in glass to improve mechanical performance of the glass by forming a compressive stress layer at the glass surface. The ion exchange process is typically carried out by dipping or immersing the glass in a salt bath. Conditions of the salt bath must be controlled to achieve a desired depth of layer (DOL) and compressive strength (CS). Time, temperature, and salt concentration in the bath are a few parameters may be used to manage CS and DOL that is ultimately obtained. As the amount of glass processed in an ion exchange bath increases, the concentration of larger cations in the bath decreases while that of the smaller cations removed from the glass during exchange increases. This phenomenon is referred to as the “poisoning” of the bath. Increased poisoning levels in the ion exchange bath over time cause gradual deterioration of the compressive stress and depth of layer achieved in the glass, and is either tolerated or addressed by continuous adjustment of process parameters such as time and temperature to maintain product specifications.

### SUMMARY

The present disclosure provides a method for optimizing ion exchange of glass. The glass is ion exchanged in a series of two ion exchange baths. The first ion exchange bath contains an amount of a poisoning ion or salt and the second ion exchange bath contains an amount of the poisoning ion or salt that is less than that in the first bath. When the concentration of the poisoning ion/salt in the first bath reaches a maximum value, the first bath is discarded and replaced by the second bath and a third bath that initially does not contain the poisoning cation/salt replaces the second ion exchange bath. This cycling of baths may be repeated to produce a plurality of glass articles, each having a surface layer under a compressive stress and depth of layer that are within predetermined limits.

Accordingly, one aspect of the disclosure is to provide a method of ion exchanging a plurality of glass articles. The method comprises: ion exchanging a first portion of the glass articles in a first ion exchange bath, the first ion exchange bath comprising a concentration of a poisoning cation that is less than or equal to a maximum concentration x and greater than or equal to a minimum concentration y; ion exchanging the first portion in a second ion exchange bath following ion exchanging the first portion in the first ion exchange bath, the second ion exchange bath comprising the poisoning cation in a concentration that is less than or equal to the minimum concentration y; replacing the first ion exchange bath with a first replacement ion exchange bath when the concentration of the poisoning cation in the first ion exchange bath exceeds the maximum concentration x, the first ion exchange replacement bath having a concentration of the poisoning ion that is less than the maximum concentration x and greater than or equal to the minimum concentration y; ion exchanging a second portion of the glass articles in the first replacement ion exchange bath; replacing the second ion exchange bath with a second replacement ion exchange bath when the concentration of the poisoning cation in the second ion exchange bath is greater than or equal to the minimum concentration y, the second ion exchange replacement bath having a poisoning ion concentration that is less than the minimum concentration y; and ion exchanging the second portion in the second replacement ion exchange bath.

A second aspect of the disclosure is to provide a method of ion exchanging a plurality of glass articles. The method comprises: carrying out a first ion exchange step by immersing a first portion of the glass articles in a first ion exchange bath at a first temperature, the ion exchange bath comprising a concentration of a first cation and a concentration of a poisoning cation, wherein the concentration of the first cation is greater than the concentration of the poisoning cation, and wherein the concentration of the poisoning cation is less than or equal to a first concentration x and greater than or equal to a second concentration y; carrying out a second ion exchange step after the first ion exchange step by immersing the glass articles in a second ion exchange bath at a second temperature, the second ion exchange bath comprising the first cation and the poisoning cation, wherein the poisoning cation is present in a concentration that is less than or equal to the second concentration y; substituting the second ion exchange bath for the first ion exchange bath in the first ion exchange step when the concentration of the poisoning cation in the first ion exchange bath is equal to the first concentration; ion exchanging a second portion of the plurality of glass articles in the second ion exchange bath at a third temperature after substituting the second ion exchange bath for the first ion exchange bath; substituting the third ion exchange bath for the second ion exchange bath in the second ion exchange step when the concentration of the poisoning cation in the second ion exchange bath is greater than or equal to the second concentration y, wherein the third ion exchange bath is at a fourth temperature, comprises the first cation and is substantially free of the poisoning cation; and ion exchanging the second portion in the third ion exchange bath at a fourth temperature after substituting the third ion exchange bath for the second ion exchange bath.

These and other aspects, advantages, and salient features will become apparent from the following detailed description, the accompanying drawings, and the appended claims.

### BRIEF DESCRIPTION OF THE DRAWINGS

FIG. 1 is a flow chart for the double ion exchange process;

FIG. 2 is a plot of the change of compressive stress for glass plotted as a function of the number of glass-holding cassettes processed in the double ion exchange baths;

FIG. 3 is a plot of poisoning salt concentration in the first and second ion exchange baths as a function of the number of glass-holding cassettes processed in the baths;

FIG. 4 is a plot of a model calculation of surface compressive stress as a function of the number of glass-holding cassettes processed when the ion exchange baths are rotated;

FIG. 5 is a plot of a model calculation of poisoning NaNO₃salt concentration for the first ion exchange bath and second ion exchange bath as a function of number of glass-holding cassettes processed;

FIG. 6 is a plot of surface compressive stress as a function of the total glass surface area processed when the first ion exchange bath temperature is varied and the second ion exchange temperature is held constant;

FIG. 7 is a plot of surface compressive stress as a function of the total glass surface area processed when the ion exchange time in each bath is varied to achieve approximately the same depths of layer and starting compressive stress values;

FIG. 8 is a plot of surface compressive stress as a function of the total glass surface area processed when the starting poisoning salt level in the first ion exchange bath is varied;

FIG. 9 is a plot of differences in predicted compressive stress and actual compressive stress for the examples listed in Table 1;

FIG. 10 is a plot of differences in predicted depth of layer and actual depth of layer for the examples listed in Table 1; and

FIG. 11 is a plot of total surface area of glass ion exchanged and process time for the examples listed in Table 1.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range as well as any ranges therebetween. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

As used herein, the terms “glass” and “glasses” includes both glasses and glass ceramics. The terms “glass article” and “glass articles” are used in their broadest sense to include any object made wholly or partly of glass and/or glass ceramic.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

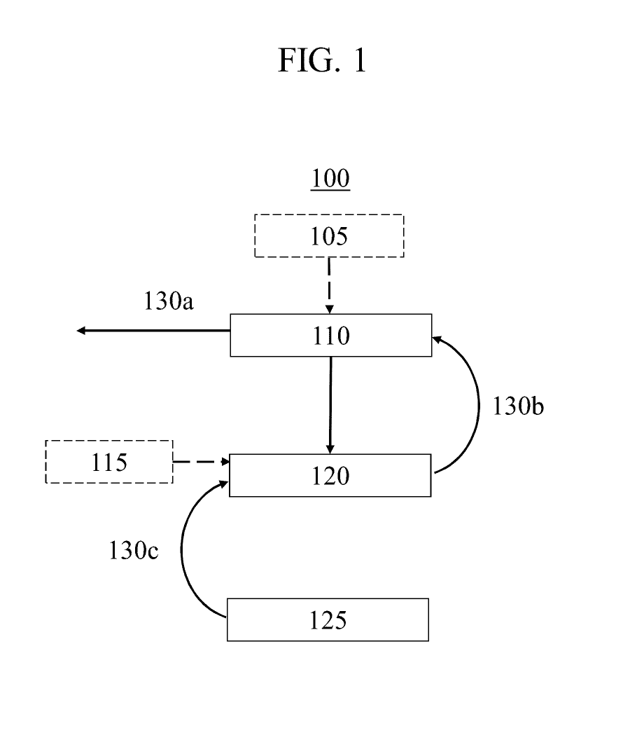

Referring to the drawings in general and to FIG. 1 in particular, it will be understood that the illustrations are for the purpose of describing particular embodiments and are not intended to limit the disclosure or appended claims thereto. The drawings are not necessarily to scale, and certain features and certain views of the drawings may be shown exaggerated in scale or in schematic in the interest of clarity and conciseness.

This disclosure is related to the technology of controlling and optimization of an ion-exchange process in which two ion-exchange baths are operated in series. In the ion-exchange process, smaller cations are replaced with within a certain depth of layer from a surface of a glass article with larger cations of the same valence (usually¹⁺) available in the salt bath to form a compressive stress layer and thus improve mechanical performance of the glass. Conditions such as time, temperature, and salt concentration in the salt bath in which the glass is immersed are controlled to achieve a desired depth of layer (DOL) and compressive stress (CS).

As the amount of glass processed in the same bath increases, the number or concentration of larger cations in the salt bath becomes depleted while the concentration of smaller cations removed or exchanged from the glass increases. This phenomenon is referred to as “poisoning” of the bath. As used herein, the terms “poisoning ions” and “poisoning cations” refer to these smaller cations that leave the glass and enter the ion exchange/salt bath during the ion exchange process and “poisoning salt” refers to the salts of such cations. The increase in concentration of poisoning cations as ion exchange progresses causes gradual deterioration of the compressive stress and depth of layer over time for glasses that are ion exchanged in the same salt bath.

The addition of a second ion exchange bath operating in series with the first ion exchange bath provides the flexibility of miming each bath at different set points, thus manipulating the stress profile of the glass within the depth of layer of ion exchange. Carrying out ion exchange in a poisoned first bath and then performing ion exchange in a relatively “unpoisoned” or “fresh” second bath may improve salt utilization rates. Some ion exchange can still be performed in the poisoned bath and the remaining ion exchange that is needed to meet specific CS and DOL requirements can be carried out in the fresh bath. In addition, carrying out ion exchange in a poisoned first bath followed by ion exchange in a second fresh bath increases the compressive stress at the surface of the glass. Moreover, the use of two ion exchange baths provides more than one set of parameters that could be used to achieve the desired CS and DOL ranges. This invention utilizes a detailed first principles model as well as experimental results to provide process understanding and control strategies to manage double ion-exchange processes and define operation windows to satisfy the objective listed above.

Described herein are double ion exchange methods that improve the consistency of both CS and DOL for a series of glass articles that are processed in the same bath or series of baths. The methods include first and second ion exchange baths operating in series to provide flexibility in operation and control of the process and modifying the stress profile in the compressive layer by independently setting time, temperature, and salt concentrations in each bath.

Accordingly, a method of ion exchanging a plurality of glass articles and optimizing salt utilization in the ion exchange process is provided. A flow chart describing the process is schematically shown in FIG. 1. In some embodiments, the method 100 includes providing a first molten salt bath (step 105) that is heated to a first temperature. The first salt bath comprises molten salts of a first cation and a poisoning cation. In some embodiments, the salts are salts of alkali metals such as, but not limited to, halides, sulfates, nitrates, nitrites, and the like. The first cation may be an alkali metal cation such as Na⁺, K⁺, Rb⁺, or Cs⁺, and the poisoning cation may be a cation of the same valence that is smaller than the first cation. In some embodiments, the poisoning cation is an alkali metal cation (alkali cation). For example, if the first cation is Na⁺, the poisoning cation may be Li⁺ and, where the first cation is K⁺, the poisoning cation may be Li⁺ or Na⁺. Depending on the size of the first cation, the poisoning cation may be a monovalent cation other than an alkali cation; e.g., Ag⁺.

In step 110, a first portion of the plurality of glass articles is ion exchanged by immersing the first portion in a first ion exchange bath, which comprises a first molten salt bath at a first predetermined temperature, which is in a range from about 380° C. to about 460° C. The entire first portion may be immersed in the first ion exchange bath at the same time or may be subdivided into smaller groups, “runs,” or lots, which undergo ion exchange in the first molten salt bath in succession. The entire first portion of glass articles, in some embodiments, has a total surface area (i.e., the sum of the area of all surfaces, including edges, of the glass articles that are exposed to the molten salt bath). The number of glass articles in the first portion—and thus the total surface area of the first portion—depends on the ion exchange time, ion exchange temperature, and the sizes of the ion exchange baths that are used in the process.

In step 110, the concentration of poisoning cations is less than or equal to a maximum concentration (x) and greater than or equal to a minimum concentration (y). As ion exchange proceeds in the first ion exchange bath, the concentration of the poisoning cation increases. When the concentration of poisoning cations in the first ion exchange bath either reaches or exceeds the maximum concentration value x, the first molten salt bath is discarded (step 130a) and replaced (step 130b) with a first replacement ion exchange bath (first replacement bath) in which the concentration of poisoning cations is less than or equal to the maximum concentration (x). In some embodiments, the second ion exchange bath 120, described herein below, is used as the first replacement bath. To facilitate overall process flow, step 130a, in some embodiments, occurs when the concentration of poisoning cations in the first molten salt bath equals the maximum concentration value x. Alternatively, the first ion exchange bath may be replaced by the first replacement bath following the ion exchange of a predetermined surface area of glass to a desired compressive stress or depth of compressive layer. Following replacement of the first ion exchange bath, a second portion of the glass articles is ion exchanged in the first replacement bath. Ion exchange of glass articles in the first replacement bath continues until the concentration of poisoning cations either reaches or exceeds the maximum value x, at which point step 130b, in which the first replacement bath is replaced by yet another molten salt bath in which the concentration of poisoning cations is less than or equal to a maximum concentration (x) and greater than or equal to a minimum concentration (y), is repeated. The first ion exchange 110, discard step 130a, and replacement step 130b of the first ion exchange bath may be repeated as many times as desired to process the plurality of glass articles. Each ion exchange run in the first ion exchange bath may proceed for a predetermined time which, in some embodiments, may range from about 30 minutes to about 40 hours. Alternatively, each ion exchange run may proceed until a desired level of compressive stress and/or depth of layer is achieved in each portion of glass articles.

Following ion exchange in the first ion exchange bath, the glass is ion exchanged in a second ion exchange bath (step 120) which comprises a second molten salt bath at a second predetermined temperature which, in some embodiments, is in a range from about 380° C. to about 460° C. Between removal of the glass articles from the first ion exchange bath and immersion in the second ion exchange bath, the glass articles may, in some embodiments, be washed, annealed, and/or preheated. In some embodiments, the method 100 further includes providing the second molten salt bath (step 115) heated to a second temperature. The second molten salt bath is, relative to the first salt bath, “fresh”—i.e., the second molten salt bath contains less of the poisoning cation than the first molten salt bath. The second molten salt bath, in some embodiments, comprises the first cation and a concentration of the second cation that is less than or, optionally, equal to the minimum concentration (y) of the first molten salt bath. In other embodiments, the second molten salt bath, when first provided, is substantially free of the poisoning cation. As ion exchange proceeds in the second ion exchange bath, the concentration of poisoning cations in the bath increases. When the concentration of poisoning cations reaches the minimum value y of the first ion exchange bath, the second ion exchange bath is replaced (step 130c) with a second replacement ion exchange bath (second replacement bath) 125 in which the concentration of the second (poisoning) cation that is less than the minimum concentration (y) of the second (poisoning) cation in the first molten salt bath the second replacement bath, in some embodiments, is heated to the second temperature. To facilitate overall process flow, the second ion exchange bath, in certain embodiments, is replaced in step 130c when the concentration of the poisoning cation in the second ion exchange bath that equal to the minimum concentration (y) of the poisoning cation in the first molten salt bath. Once replaced, the second molten salt bath may be rotated to the first ion exchange bath position (step 130b) and used as the first replacement ion exchange bath in the first ion exchange step.

Ion exchange in the second ion exchange bath may continue for a time period sufficient to achieve a desired compressive stress or depth of compressive layer or to a compressive stress and/or depth of layer that are within a predetermined range. In some embodiments, the glass is ion exchanged such that the compressive stress is within a range from about 700 megapascals (MPa) to about 900 MPa. In some embodiments, the glass is ion exchanged to achieve a compressive stress layer having a depth of layer of at least about 41 μm. The second ion exchange step 120 and replacement cycles 130b, 130c of the second ion exchange bath may be repeated as many times as desired. The glass articles may, in some embodiments, be washed and/or annealed following removal of the glass articles from the second ion exchange bath.

In some embodiments, the first ion exchange bath and the second ion exchange bath are held at the same temperature. In other embodiments, however, the temperature (first temperature) of the first ion exchange bath and the temperature (second temperature) of the second ion exchange bath are not equal to each other. In some embodiments, the second temperature is greater than the first temperature. In certain embodiments, the second temperature is from about 5° C. to about 40° C. greater than the second temperature. In those embodiments where the first and second temperatures are different, replacement of the first ion exchange bath with the second ion exchange bath (step 130b in FIG. 1) includes heating or cooling the second ion exchange bath from the first temperature to the second temperature.

When the glass is ion exchanged using a single bath ion exchange process (SIOX), product specifications expressed in terms of CS and DOL can be achieved through a limited set of salt bath parameters. Time, temperature, and salt concentration of the bath are key parameters impacting the CS and DOL for a given thickness. Ion-exchange time affects the process throughput and all downstream processing units; it is therefore desirable to keep the ion exchange time constant in a manufacturing setting. Salt bath concentration changes continuously, as the concentration of poisoning cations in the molten salt bath increases as the amount of glass processed in the bath increases. Ion exchange time is typically held affixed to facilitate process flow; i.e., the flow of material through the various pre- and post-ion exchange operations, such as heating, washing, drying, and the like. Thus, temperature is the only parameter that can be adjusted to meet the CS and DOL requirements during production as salt bath poisoning increases over time.

In the present double ion exchange process in which two baths are operated in series, the degrees of freedom to optimize and control the overall ion exchange process are increased, since there are six parameters (time, temperature, and salt concentration for each ion exchange bath) that may be used to achieve CS and DOL requirements. In addition, the double ion exchange methods described herein enable achieving compressive stresses at the surface of the glass and depths of layer that are similar to those obtained by single ion exchange, but also enable the creation of different compressive stress profiles within the compressive stress layer by modifying the process parameters in each ion exchange bath.

By studying the impact of each parameter on salt utilization rates, the present disclosure identifies the set of parameters that maximizes the salt bath utilization rates while maintaining CS and DOL specifications. The amount of poisoning cations accumulated in each ion exchange bath for the double ion exchange process with respect to the area of glass being processed is estimated with the aid of a physics-based model that takes into account diffusivity, temperature, bath poisoning, force balance, and stress relaxation. This model is used as a starting point to develop a set of conditions such as time, salt concentrations, and the like, for experimentation and validation. A KNO₃ molten salt bath poisoned with NaNO₃ was used in the model. While the following discussion describes the ion exchange of K⁺ ions for Na⁺ ions in the glass in molten salt baths comprising potassium and sodium nitrate, it is understood that the discussion applies equally to other cations and molten salt bath compositions as previously described hereinabove.

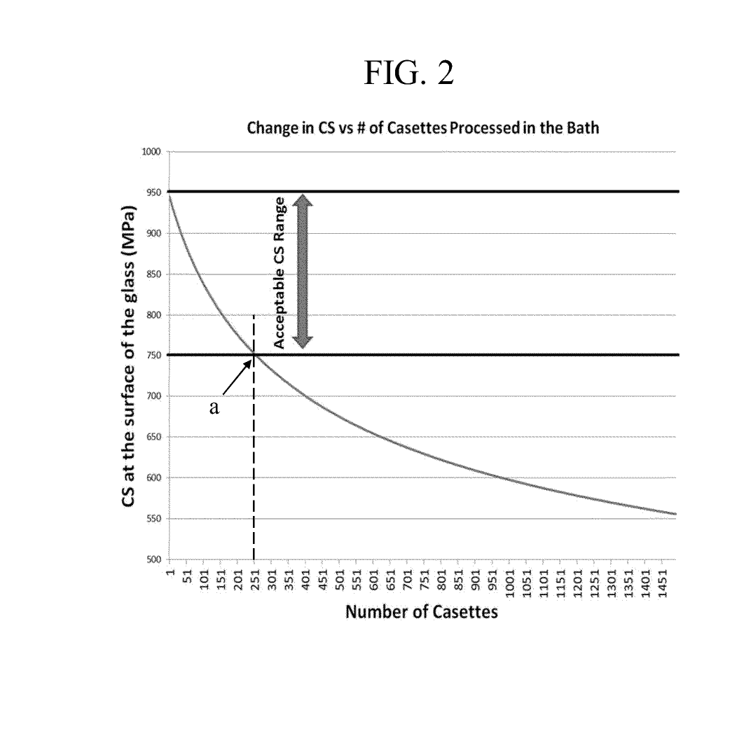

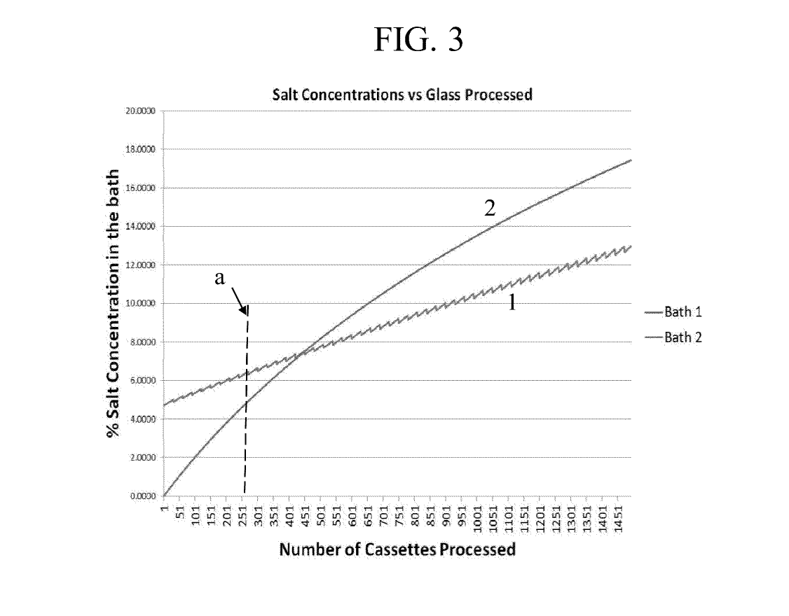

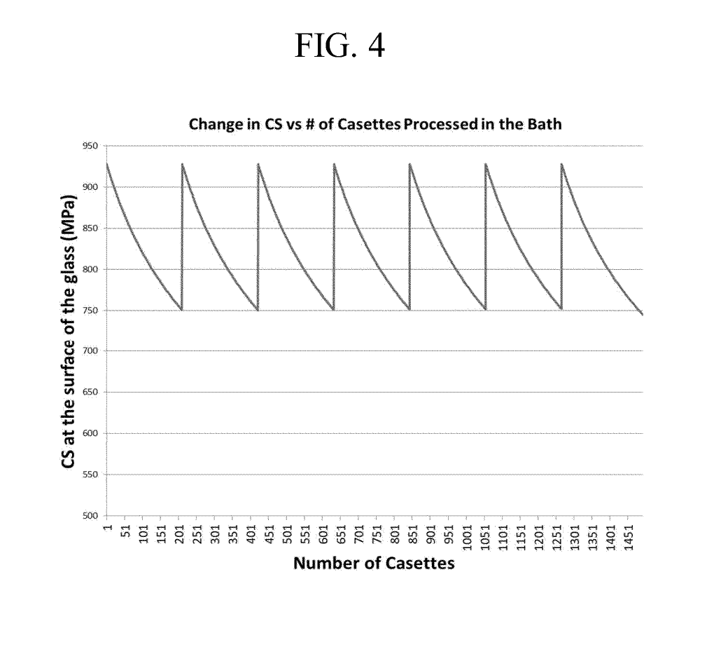

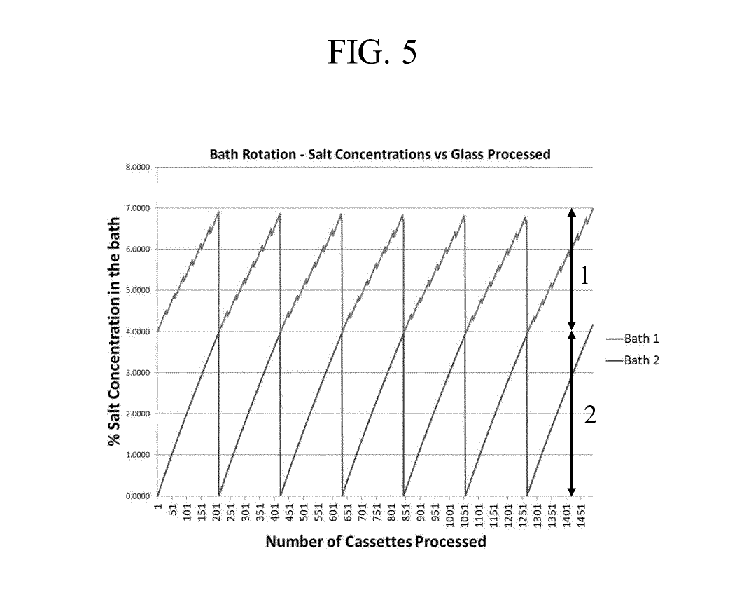

The reduction of compressive stress at the surface of the glass as the molten salt baths become poisoned is plotted in FIG. 2 as a function of the number of glass-holding cassettes processed in the ion exchange baths. The number of cassettes is representative of the quantity and surface area of glass that is processed. Calculated levels of poisoning cation salts (also referred to as “poisoning salts”) in the first ion exchange bath (1) and second ion exchange bath (2) are plotted in FIG. 3. To improve final compressive stress in the glass, the starting poisoning salt level in the first bath is chosen to be higher than that of the second ion exchange bath. When the compressive stress level obtained from the process drops to about 750 MPa at around the 250^{th} cassette (point a in FIGS. 2 and 3), the poisoning NaNO₃ salt concentration in the first ion exchange bath is expected to exceed about 6% NaNO₃ and would, in some embodiments, be discarded (step 130 in FIG. 1). At the same time, the poisoning NaNO₃ concentration in the second ion exchange bath is expected to reach about 4% and, in some embodiments, will replace the first bath (step 130b in FIG. 1) and a fresh bath with 0% NaNO₃ will be introduced as the second bath (step 130c in FIG. 1). This rotation should restore the compressive stress levels to about 950 MPa, which is the higher end of the acceptable CS range. A model calculation of surface compressive stress (CS) as a function of the number of cassettes of glass processed is plotted in FIG. 4. FIG. 5 is a plot of a model calculation of poisoning salt concentration (expressed in wt % NaNO₃) for the first ion exchange bath (1 in FIG. 5) and second ion exchange bath (2 in FIG. 5) as a function of number of cassettes of glass processed using the same conditions as those used in the calculations shown in in FIG. 4. The plots shown in FIGS. 4 and 5 represent those embodiments in which the ion exchange bath replacement procedure described herein is repeated continuously.

The present methods optimize three factors. First, process parameters are established such that when the compressive stress decreases to a lower limit and the bath rotation takes place (e.g. steps 130a-c in FIG. 1), the concentration of the poisoning salt/cation (e.g., NaNO₃ in a KNO₃ salt bath), in the second ion exchange bath should be equal to minimum concentration of the poisoning salt/cation of the first bath. If this condition is not satisfied, the starting/minimum concentration of the poisoning salt/cation in the first ion exchange bath will vary after each rotation of ion exchange baths (i.e., steps 130a-c in FIG. 1), resulting in suboptimal operation of the ion exchange process. Secondly, process parameters should be established such that the rate of compressive stress reduction is as low as possible as poisoning of the ion exchange baths increases. This will help improve the rate of salt utilization, expressed in kilograms of salt consumed per square meter of ion exchanged surface area of glass, and reduce the number of rotations of ion exchange baths needed to process a given quantity or surface area of glass. Thirdly, the amount of ion exchange taking place in each molten salt bath should be adjusted such that use of the poisoned first bath is maximized before being discarded.

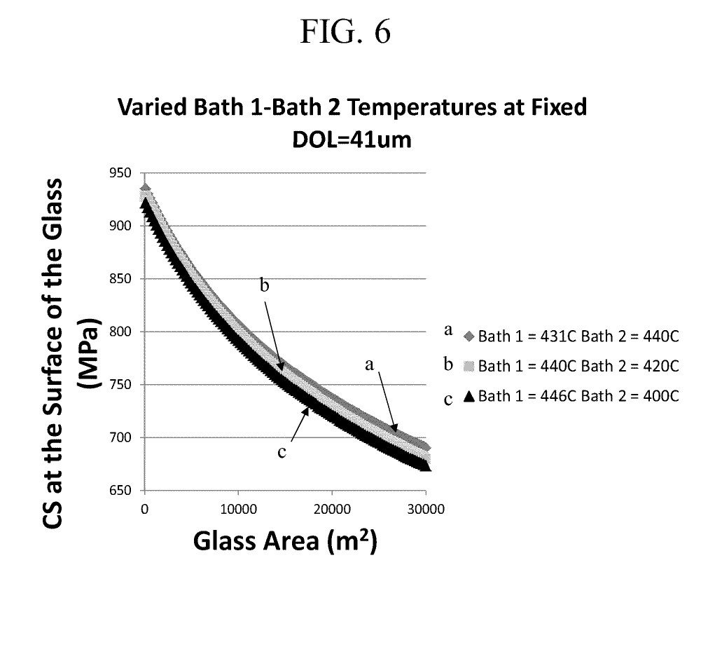

In order to develop the optimized process conditions, process sensitivities of the six parameters (time, temperature, and NaNO₃ concentrations in each ion exchange bath) are studied while preserving target compressive stress and depth of layer values. It is possible to maintain the target CS and DOL by changing the temperatures in opposite directions. The magnitude of the change depends on the ion exchange time and poisoning levels on each bath. FIG. 6 is a plot of the effect of the temperatures of the first and second ion exchange baths on the resulting compressive stress. For the data shown in FIG. 6, the initial poisoning salt concentration in the first ion exchange bath is set at 4% NaNO₃ poisoning levels and the ion exchange time is set at 160 minutes. The initial poisoning salt concentration in the second ion exchange bath is set at 0% NaNO₃ ant the ion exchange time is set at 80 minutes. At constant DOL and starting CS values, the various combinations of first and second ion exchange bath temperatures combinations shown in FIG. 6 suggest that improved salt utilization rates may be achieved when the temperature of the first ion exchange bath is kept lower than the temperature of the second ion exchange bath. Based on model predictions, approximately 17,770 m² of glass may be ion exchanged under the conditions (time, initial and final poisoning salt concentrations) described above before the compressive stress drops below 750 MPa when the temperature of the first ion exchange bath is maintained at 431° C., and the second ion exchange bath is maintained at 440° C. (a in FIG. 6). When the temperature of the first ion exchange bath is maintained at 440° C. and the second ion exchange bath is maintained at 420° C. (b in FIG. 6) about 16,240 m² of glass may be ion exchanged before the compressive stress drops below 750 MPa. About 15,240 m² of glass may be ion exchanged before the compressive stress drops below 750 MPa when the temperature of the first ion exchange bath is maintained at 446° C. and the second ion exchange bath is maintained at 400° C. (c in FIG. 6).

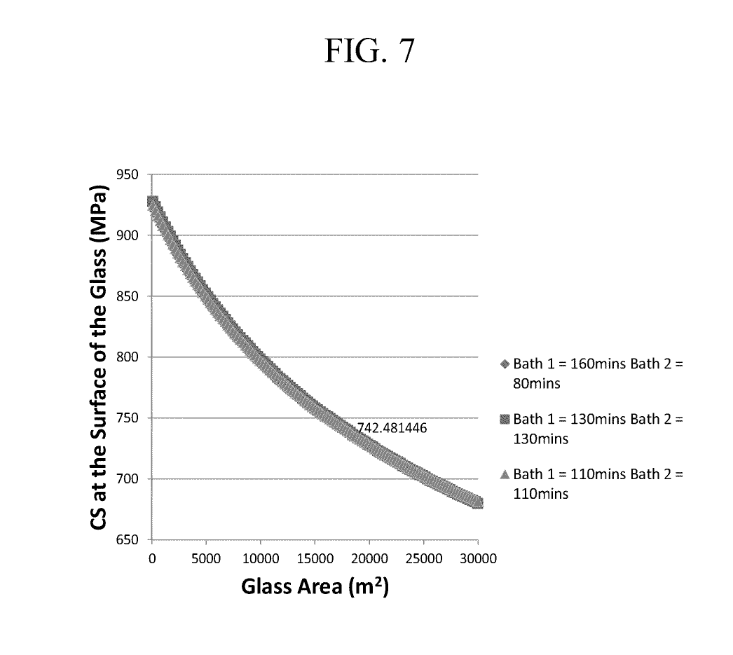

Similar calculations are performed in which the ion exchange time in each bath is varied to achieve approximately the same depths of layer and starting compressive stress values. For these calculations, the initial poisoning salt concentration in the first ion exchange bath is set at 4% NaNO₃ and the bath is maintained at a temperature of 440° C. and the initial poisoning salt concentration in the second ion exchange bath is set at 0% NaNO₃ and the bath is maintained at a temperature of 420° C. Results of this study, which are plotted FIG. 7, do not indicate any significant change in salt utilization rates as the time in each ion exchange bath is varied.

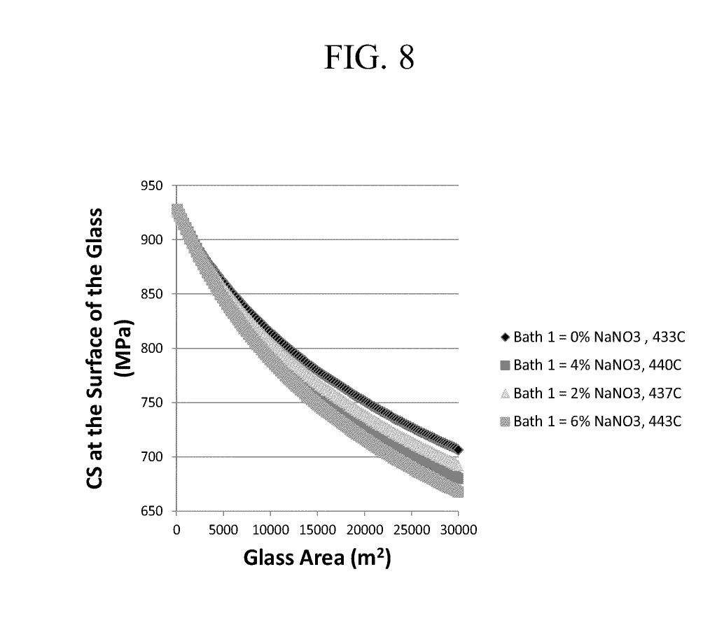

It is not possible to perform similar calculations in which the poisoning salt level in each ion exchange bath is varied. As the poisoning salt levels in the ion exchange baths are varied relative to each other, compressive stress values change significantly and it is therefore not possible impose constant CS and DOL constraints. In the data shown in FIG. 8, the starting poisoning salt level in the first ion exchange bath is varied (0 wt %, 2 wt %, 4 wt %, and 6 wt % NaNO₃) and the temperature in the bath is used to maintain constant CS and DOL values. FIG. 8 suggests low starting concentrations of the poisoning salt improve the rate salt utilization—i.e., a greater total surface area of glass can be ion exchange before the resulting compressive stress drops below a lower acceptable limit (here, about 750 MPa).

Based on the observations made from the modeling results described above, experiments were designed to validate some of the conditions calculated by the model and establish process options for double ion exchange such as enabling faster ion exchange and optimization of bath lifetime. As shown in FIG. 6, decreasing the temperature of the first ion exchange bath while increasing the second ion exchange bath temperature to maintain target CS and DOL increases salt bath life, as the CS reduction curve is flattened as the area of glass processed increases. Moving the ion exchange process in that direction within the process temperature limitations is therefore beneficial.

In the experiments described herein, the targeted compressive stress and depth of layer after the second ion exchange step in a fresh KNO₃ bath were 911±30 MPa and 41±3 microns (μm), respectively and the lower compressive stress limit as the molten salt bath approaches the end of bath life time was set at 750 MPa. Alkali aluminosilicate glass samples (50 mm×50 mm, 0.7 mm thick) were ion exchanged in the first ion exchange bath (Stage 1) followed by ion exchange in the second ion exchange bath (Stage 2) under the conditions listed in Table 1. The experiments were designed as paired conditions: examples 1, 3, 5, 7, and 9 simulated bath conditions at the beginning of each ion exchange bath rotation, whereas examples 2, 4, 6, 8, and 10 were conducted to validate end of bath life conditions for examples 1, 3, 5, 7, and 9, respectively, based on poisoning levels predicted by the model described hereinabove. Salt concentrations in the ion exchange baths were measured using inductively coupled plasma (ICP). Presently used baseline ion exchange conditions in which the temperature of the first ion exchange bath is higher than that the second bath were represented in examples 3 and 4. Examples 5 and 6 represent ion exchange conditions in which the temperature of the first ion exchange bath is less than that of the second bath. Examples 1 and 2 represent ion exchange conditions in which the first and second ion exchange baths are at the same temperature, the ion exchange time in the first bath is decreased, and the ion exchange time in the second bath is increased. The results obtained for examples 1-4 showed improved bath life compared to baseline ion exchange conditions. The ion exchange conditions used in examples 7-10 were designed to shorten the total ion exchange time while maintaining ion exchange bath life that is comparable to that of examples 1-4.

Compressive stress and depth of layer are measured using those means known in the art. Such means include, but are not limited to, measurement of surface stress (FSM) using commercially available instruments such as the FSM-6000, manufactured by Luceo Co., Ltd. (Tokyo, Japan), or the like, and methods of measuring compressive stress and depth of layer are described in ASTM 1422C-99, entitled “Standard Specification for Chemically Strengthened Flat Glass,” and ASTM 1279.19779 “Standard Test Method for Non-Destructive Photoelastic Measurement of Edge and Surface Stresses in Annealed, Heat-Strengthened, and Fully-Tempered Flat Glass,” the contents of which are incorporated herein by reference in their entirety. Surface stress measurements rely upon the accurate measurement of the stress optical coefficient (SOC), which is related to the birefringence of the glass. SOC in turn is measured by those methods that are known in the art, such as fiber and four point bend methods, both of which are described in ASTM standard C770-98 (2008), entitled “Standard Test Method for Measurement of Glass Stress-Optical Coefficient,” the contents of which are incorporated herein by reference in their entirety, and a bulk cylinder method. Using these measurement techniques, surface compressive stress and depth of layer may be determined to within ±20 MPa and ±3 μm, respectively.

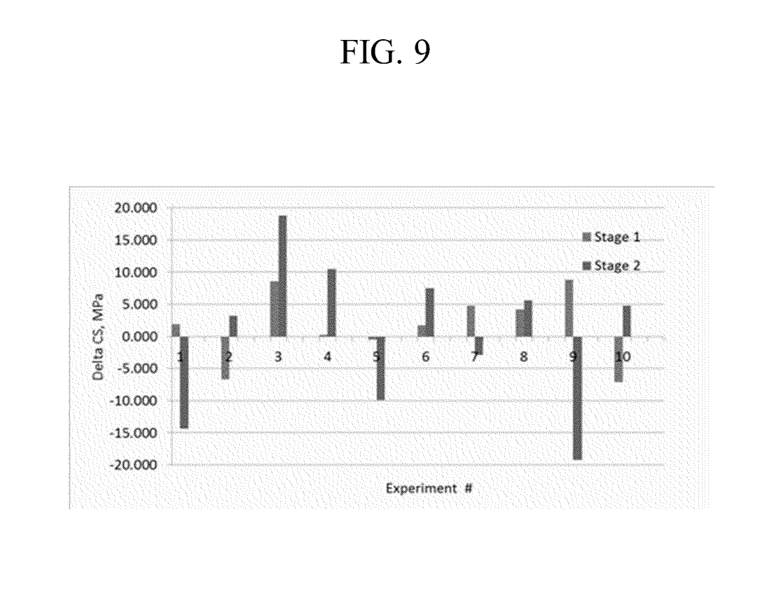

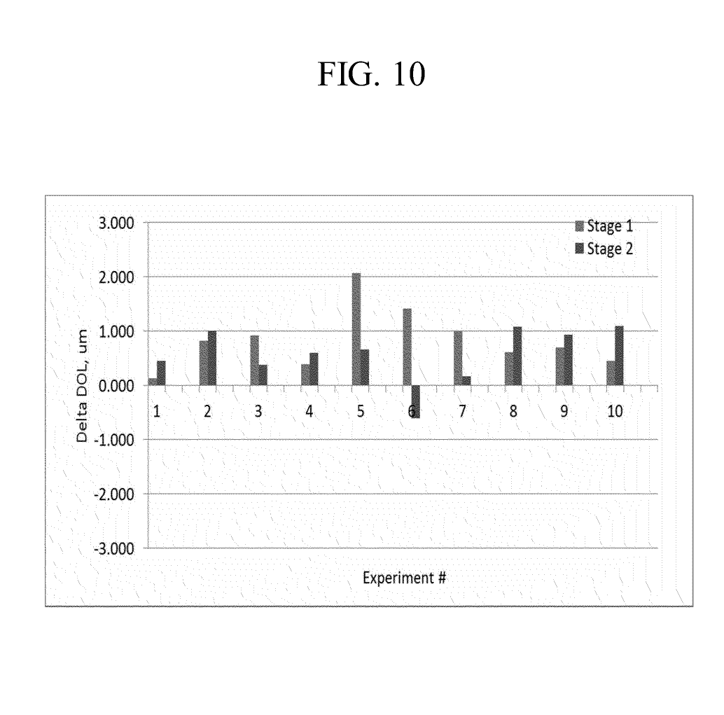

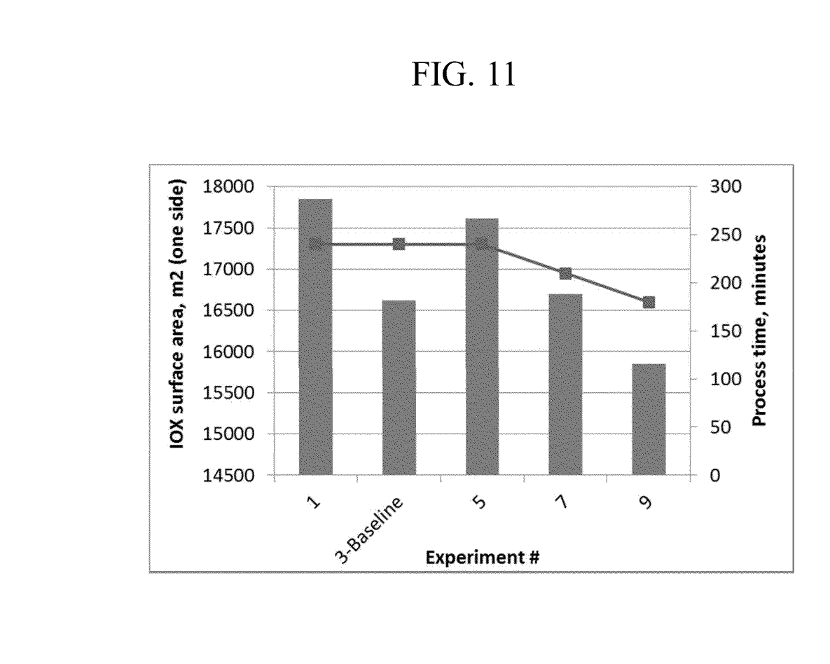

The compressive stress and depth of layer values listed in Table 2 indicate good agreement between the predicted and actual CS and DOL. The differences between predicted and actual CS and DOL values are plotted in FIGS. 9 and 10, respectively. The two sets of the data are well within measurement error/equipment uncertainty of each other. The total surface area of glass ion exchanged and process time are plotted in FIG. 11 for examples 1, 3, 5, 7, and 9. The process parameters used in examples 1 and 5 provide improved yield over the baseline process parameters (example 3) within approximately the same process time. The parameters used in example 7may be used to shorten the overall ion exchange time while providing a process yield that is comparable to that of baseline conditions.

TABLE 1
Double ion exchange conditions

| | Stage 1 ion exchange | | | Stage 2 ion exchange | | | |
|---|---|---|---|---|---|---|---|
| | Temperature | Time | NaNO₃ | Temperature | Time | NaNO₃ | |
| Example | (° C.) | (min) | wt % | (° C.) | (min) | wt % | Notes |
| 1 | 432 | 80 | 4.2 | 432 | 160 | 0 | Fresh bath |
| 2 | 432 | 80 | 6.27 | 432 | 160 | 4.18 | End of bath life |
| 3 | 440 | 160 | 4 | 420 | 80 | 0 | Fresh bath |
| 4 | 440 | 160 | 6.86 | 420 | 80 | 4 | End of bath life |
| 5 | 431 | 160 | 4.2 | 440 | 80 | 0 | Fresh bath |
| 6 | 431 | 160 | 7 | 440 | 80 | 4.2 | End of bath life |
| 7 | 439 | 120 | 3.9 | 439 | 90 | 0 | Fresh bath |
| 8 | 439 | 120 | 6.4 | 439 | 90 | 3.9 | End of bath life |
| 9 | 445 | 90 | 3.7 | 445 | 90 | 0 | Fresh bath |
| 10 | 445 | 90 | 6 | 445 | 90 | 3.7 | End of bath life |

TABLE 2
Predicted and actual compressive stress and depth of layer
for double ion exchanged examples in Table 1

| | |
|---|---|
| Predicted | Actual |

| Example | CS (MPa) | DOL (μm) | CS (MPa) | DOL (μm) |
|---|---|---|---|---|
| 1 | 929 | 41 | 917 | 41 |
| 2 | 750 | 41 | 753 | 42 |
| 3 | 926 | 41 | 947 | 41 |
| 4 | 749 | 41 | 760 | 42 |
| 5 | 931 | 41 | 924 | 42 |
| 6 | 750 | 42 | 757 | 41 |
| 7 | 921 | 41 | 922 | 41 |
| 8 | 750 | 41 | 757 | 42 |
| 9 | 912 | 41 | 898 | 42 |
| 10 | 749 | 41 | 754 | 42 |

The ion exchange methods described herein may be used to ion exchange any ion exchangeable glass. In particular embodiments, the methods may be used to ion exchange alkali aluminosilicate glasses. In some embodiments, the glass has a thickness of less than or equal to about 1 mm and, in some embodiments form about 0.3 mm to about 1 mm.

In one embodiment, the alkali aluminosilicate glass comprises: at least one of alumina and boron oxide, and at least one of an alkali metal oxide and an alkali earth metal oxide, wherein −15 mol %≦(R₂O+R′O−Al₂O₃−ZrO₂)−B₂O₃≦4 mol %, where R is one of Li, Na, K, Rb, and Cs, and R′ is one of Mg, Ca, Sr, and Ba. In some embodiments, the alkali aluminosilicate glass comprises: from about 62 mol % to about 70 mol.% SiO₂; from 0 mol % to about 18 mol % Al₂O₃; from 0 mol % to about 10 mol % B₂O₃; from 0 mol % to about 15 mol % Li₂O; from 0 mol % to about 20 mol % Na₂O; from 0 mol % to about 18 mol % K₂O; from 0 mol % to about 17 mol % MgO; from 0 mol % to about 18 mol % CaO; and from 0 mol % to about 5 mol % ZrO₂. The glass is described in U.S. patent application Ser. No. 12/277,573 by Matthew J. Dejneka et al., entitled “Glasses Having Improved Toughness and Scratch Resistance,” filed Nov. 25, 2008, and claiming priority to U.S. Provisional Patent Application No. 61/004,677, filed on Nov. 29, 2008, the contents of which are incorporated herein by reference in their entirety.

In another embodiment, the alkali aluminosilicate glass comprises: from about 60 mol % to about 70 mol % SiO₂; from about 6 mol % to about 14 mol % Al₂O₃; from 0 mol % to about 15 mol % B₂O₃; from 0 mol % to about 15 mol % Li₂O; from 0 mol % to about 20 mol % Na₂O; from 0 mol % to about 10 mol % K₂O; from 0 mol % to about 8 mol % MgO; from 0 mol % to about 10 mol % CaO; from 0 mol % to about 5 mol % ZrO₂; from 0 mol % to about 1 mol % SnO₂; from 0 mol % to about 1 mol % CeO₂; less than about 50 ppm As₂O₃; and less than about 50 ppm Sb₂O₃; wherein 12 mol %≦Li₂O+Na₂O+K₂O≦20 mol % and 0 mol %≦MgO+CaO≦10 mol %. The glass is described in U.S. Pat. No. 8,158,543 by Sinue Gomez et al., entitled “Fining Agents for Silicate Glasses,” issued on February Apr. 17, 2012, and claiming priority to U.S. Provisional Patent Application No. 61/067,130, filed on Feb. 26, 2008, the contents of which are incorporated herein by reference in their entirety.

In another embodiment, the alkali aluminosilicate glass has a seed concentration of less than about 1 seed/cm³ and comprises: from about 60 mol % to about 72 mol % SiO₂; from about 6 mol % to about 14 mol % Al₂O₃; from 0 mol % to about 15 mol % B₂O₃; from 0 mol % to about 1 mol % Li₂O; from 0 mol % to about 20 mol % Na₂O; from 0 mol % to about 10 mol % K₂O; from 0 mol % to about 2.5 mol % CaO; from 0 mol % to about 5 mol % ZrO₂; from 0 mol % to about 1 mol % SnO₂; and from 0 mol % to about 1 mol % CeO₂, wherein 12 mol %≦Li₂O+Na₂O+K₂O≦20 mol %, and wherein the silicate glass comprises less than 50 ppm As₂O₃. In other embodiments, the silicate glass comprises: from about 60 mol % to about 72 mol % SiO₂; from about 6 mol % to about 14 mol % Al₂O₃; from about 0.63 mol % to about 15 mol % B₂O₃; from 0 mol % to about 1 mol % Li₂O; from 0 mol % to about 20 mol % Na₂O; from 0 mol % to about 10 mol % K₂O; from 0 mol % to about 10 mol % CaO; from 0 mol % to about 5 mol % ZrO₂; from 0 mol % to about 1 mol % SnO₂; and from 0 mol % to about 1 mol % CeO₂, wherein 12 mol %≦Li₂O+Na₂O+K₂O≦20 mol %. In further embodiments, the silicate glass comprises: from about 60 mol % to about 72 mol % SiO₂; from about 6 mol % to about 14 mol % Al₂O₃; from 0 mol % to about 15 mol % B₂O₃; from 0 mol % to about 1 mol % Li₂O; from 0 mol % to about 20 mol % Na₂O; from 0 mol % to about 10 mol % K₂O; from 0 mol % to about 10 mol % CaO; from 0 mol % to about 5 mol % ZrO₂; from 0 mol % to about 1 mol % SnO₂; and from 0 mol % to about 1 mol % CeO₂, wherein 12 mol %≦Li₂O+Na₂O+K₂O≦20 mol %, wherein 0.1 mol %≦SnO₂+CeO₂≦2 mol %, and wherein the silicate glass is formed from batch or raw materials that include at least one oxidizer fining agent. The glass is described in U.S. Pat. No. 8,431,502 by Sinue Gomez et al., entitled “Silicate Glasses Having Low Seed Concentration,” issued on February Apr. 30, 2013, and claiming priority to U.S. Provisional Patent Application No. 61/067,130, filed on Feb. 26, 2008, the contents of which are incorporated herein by reference in their entirety.

In another embodiment, the alkali aluminosilicate glass comprises SiO₂ and Na₂O, wherein the glass has a temperature T₃₅ₖₚ at which the glass has a viscosity of 35 kilo poise (kpoise), wherein the temperature T_{breakdown} at which zircon breaks down to form ZrO₂ and SiO₂ is greater than T₃₅ₖₚ. In some embodiments, the alkali aluminosilicate glass comprises: from about 61 mol % to about 75 mol % SiO₂; from about 7 mol % to about 15 mol % Al₂O₃; from 0 mol % to about 12 mol % B₂O₃; from about 9 mol % to about 21 mol % Na₂O; from 0 mol % to about 4 mol % K₂O; from 0 mol % to about 7 mol % MgO; and 0 mol % to about 3 mol % CaO. The glass is described in U.S. patent application Ser. No. 12/856,840 by Matthew J. Dejneka et al., entitled “Zircon Compatible Glasses for Down Draw,” filed Aug. 10, 2010, and claiming priority to U.S. Provisional Patent Application No. 61/235,762, filed on Aug. 29, 2009, the contents of which are incorporated herein by reference in their entirety.

In another embodiment, the alkali aluminosilicate glass comprises at least 50 mol % SiO₂ and at least one modifier selected from the group consisting of alkali metal oxides and alkaline earth metal oxides, wherein [(Al₂O₃ (mol %)+B₂O₃(mol %))/(Σ alkali metal modifiers (mol %))]>1. In some embodiments, the alkali aluminosilicate glass comprises: from 50 mol % to about 72 mol % SiO₂; from about 9 mol % to about 17 mol % Al₂O₃; from about 2 mol % to about 12 mol % B₂O₃; from about 8 mol % to about 16 mol % Na₂O; and from 0 mol % to about 4 mol % K₂O. The glass is described in U.S. patent application Ser. No. 12/858,490 by Kristen L. Barefoot et al., entitled “Crack And Scratch Resistant Glass and Enclosures Made Therefrom,” filed Aug. 18, 2010, and claiming priority to U.S. Provisional Patent Application No. 61/235,767, filed on Aug. 21, 2009, the contents of which are incorporated herein by reference in their entirety.

In another embodiment, the alkali aluminosilicate glass comprises SiO₂, Al₂O₃, P₂O₅, and at least one alkali metal oxide (R₂O), wherein 0.75≦[P₂O₅(mol %)+R₂O(mol %))/M₂O₃ (mol %)]≦1.2, where M₂O₃═Al₂O₃+B₂O₃. In some embodiments, the alkali aluminosilicate glass comprises: from about 40 mol % to about 70 mol % SiO₂; from 0 mol % to about 28 mol % B₂O₃; from 0 mol % to about 28 mol % Al₂O₃; from about 1 mol % to about 14 mol % P₂O₅; and from about 12 mol % to about 16 mol % R₂O; and, in certain embodiments, from about 40 to about 64 mol % SiO₂; from 0 mol % to about 8 mol % B₂O₃; from about 16 mol % to about 28 mol % Al₂O₃; from about 2 mol % to about 12% P₂O₅; and from about 12 mol % to about 16 mol % R₂O. The glass is described in U.S. patent application Ser. No. 13/305,271 by Dana C. Bookbinder et al., entitled “Ion Exchangeable Glass with Deep Compressive Layer and High Damage Threshold,” filed Nov. 28, 2011, and claiming priority to U.S. Provisional Patent Application No. 61/417,941, filed Nov. 30, 2010, the contents of which are incorporated herein by reference in their entirety.

In still other embodiments, the alkali aluminosilicate glass comprises at least about 4 mol % P₂O₅, wherein (M₂O₃(mol %)/RₓO (mol %))<1, wherein M₂O₃═Al₂O₃+B₂O₃, and wherein RₓO is the sum of monovalent and divalent cation oxides present in the alkali aluminosilicate glass. In some embodiments, the monovalent and divalent cation oxides are selected from the group consisting of Li₂O, Na₂O, K₂O, Rb₂O, Cs₂O, MgO, CaO, SrO, BaO, and ZnO. In some embodiments, the glass comprises 0 mol % B₂O₃. The glass is described in U.S. patent application Ser. No. 13/678,013 by Timothy M. Gross, entitled “Ion Exchangeable Glass with High Crack Initiation Threshold,” filed Nov. 15, 2012, and claiming priority to U.S. Provisional Patent Application No. 61/560,434 filed Nov. 16, 2011, the contents of which are incorporated herein by reference in their entirety.

In still another embodiment, the alkali aluminosilicate glass comprises at least about 50 mol % SiO₂ and at least about 11 mol % Na₂O, and the compressive stress is at least about 900 MPa. In some embodiments, the glass further comprises Al₂O₃ and at least one of B₂O₃, K₂O, MgO and ZnO, wherein −340+27.1.Al₂O₃−28.7.B₂O₃+15.6.Na₂O−61.4.K₂O+8.1.(MgO+ZnO)≧0 mol %. In particular embodiments, the glass comprises: from about 7 mol % to about 26 mol % Al₂O₃; from 0 mol % to about 9 mol % B₂O₃; from about 11 mol % to about 25 mol % Na₂O; from 0 mol % to about 2.5 mol % K₂O; from 0 mol % to about 8.5 mol % MgO; and from 0 mol % to about 1.5 mol % CaO. The glass is described in U.S. patent application Ser. No. 13/533,298, by Matthew J. Dejneka et al., entitled “Ion Exchangeable Glass with High Compressive Stress,” filed Jun. 26, 2012, and claiming priority to U.S. Provisional Patent Application No. 61/503,734, filed Jul. 1, 2011, the contents of which are incorporated herein by reference in their entirety.

In some embodiments, the glass comprises: at least about 50 mol % SiO₂; at least about 10 mol % R₂O, wherein R₂O comprises Na₂O; Al₂O₃; and B₂O₃, wherein B₂O₃—(R₂O—Al₂O₃)≧3 mol %. In certain embodiments, the glass comprises: at least about 50 mol % SiO₂; from about 9 mol % to about 22 mol % Al₂O₃; from about 3 mol % to about 10 mol % B₂O₃; from about 9 mol % to about 20 mol % Na₂O; from 0 mol % to about 5 mol % K₂O; at least about 0.1 mol % MgO, ZnO, or combinations thereof, wherein 0≦MgO≦6 and 0≦ZnO≦6 mol %; and, optionally, at least one of CaO, BaO, and SrO, wherein 0 mol %≦CaO+SrO+BaO≦2 mol %. When ion exchanged, the glass, in some embodiments, has a Vickers crack initiation threshold of at least about 10 kgf. Such glasses are described in U.S. Provisional Patent Application No. 61/653,489, by Matthew J. Dejneka et al., entitled “Zircon Compatible, Ion Exchangeable Glass with High Damage Resistance,” filed May 31, 2012, the contents of which are incorporated by reference herein in their entirety.

In some embodiments, the glass comprises: at least about 50 mol % SiO₂; at least about 10 mol % R₂O, wherein R₂O comprises Na₂O; Al₂O₃, wherein −0.5 mol %≦Al₂O₃(mol %)−R₂O(mol %)≦2 mol %; and B₂O₃, and wherein B₂O₃(mol %)−(R₂O(mol %)−Al₂O₃(mol %))≧4.5 mol %. In other embodiments, the glass has a zircon breakdown temperature that is equal to the temperature at which the glass has a viscosity of greater than about 40 kPoise and comprises: at least about 50 mol % SiO₂; at least about 10 mol % R₂O, wherein R₂O comprises Na₂O; Al₂O₃; and B₂O₃, wherein B₂O₃(mol %)−(R₂O(mol %)−Al₂O₃(mol %))≧4.5 mol %. In still other embodiments, the glass is ion exchanged, has a Vickers crack initiation threshold of at least about 30 kgf, and comprises: at least about 50 mol % SiO₂; at least about 10 mol % R₂O, wherein R₂O comprises Na₂O; Al₂O₃, wherein −0.5 mol %≦Al₂O₃(mol %)−R₂O(mol %)≦2 mol %; and B₂O₃, wherein B₂O₃(mol %)−(R₂O(mol %)−Al₂O₃(mol %))≧4.5 mol %. Such glasses are described in U.S. Provisional Patent Application No. 61/653,485, by Matthew J. Dejneka et al., entitled “Zircon Compatible, Ion Exchangeable Glass with High Damage Resistance,” filed May 31, 2012, the contents of which are incorporated by reference herein in their entirety.

In some embodiments, the alkali aluminosilicate glasses described hereinabove are substantially free of (i.e., contain 0 mol % of) of at least one of lithium, boron, barium, strontium, bismuth, antimony, and arsenic.

In some embodiments, the alkali aluminosilicate glasses described hereinabove are down-drawable by processes known in the art, such as slot-drawing, fusion drawing, re-drawing, and the like, and has a liquidus viscosity of at least 130 kilopoise.

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

1. A method of ion exchanging a plurality of glass articles, the method comprising:
a. ion exchanging a first portion of the glass articles in a first ion exchange bath, the first ion exchange bath comprising a concentration of a poisoning cation that is less than or equal to a maximum concentration x and greater than or equal to a minimum concentration y;
b. ion exchanging the first portion in a second ion exchange bath following ion exchanging the first portion in the first ion exchange bath, the second ion exchange bath comprising the poisoning cation in a concentration that is less than or equal to the minimum concentration y;
c. replacing the first ion exchange bath with a first replacement ion exchange bath when the concentration of the poisoning cation in the first ion exchange bath exceeds the maximum concentration x, the first ion exchange replacement bath having a concentration of the poisoning ion that is less than the maximum concentration x and greater than or equal to the minimum concentration y;
d. ion exchanging a second portion of the glass articles in the first replacement ion exchange bath;
e. replacing the second ion exchange bath with a second replacement ion exchange bath when the concentration of the poisoning cation in the second ion exchange bath is greater than or equal to the minimum concentration y, the second ion exchange replacement bath having a poisoning ion concentration that is less than the minimum concentration y; and
f. ion exchanging the second portion in the second replacement ion exchange bath.

2. The method of claim 1, wherein each of the ion exchanged plurality of glass articles has a compressive layer in a range from about 700 MPa up to about 900 MPa, the compressive layer extending from a surface to a depth of layer.

3. The method of claim 1, wherein the minimum concentration of the poisoning cation is about 4 wt %.

4. The method of claim 1, wherein the maximum concentration of the poisoning ion is about 6 wt %.

5. The method of claim 1, wherein each of the first ion exchange bath, second ion exchange bath, first replacement ion exchange bath, and second ion exchange bath comprises a first cation, the first cation being larger that the poisoning cation and present in a concentration that is greater than the concentration of the poisoning cation.

6. The method of claim 5, wherein the first cation is an alkali metal cation and the poisoning cation is one of an alkali cation and a monovalent metal cation.

7. The method of claim 5, wherein the first cation is K⁺ and the second cation is Na⁺.

8. The method of claim 1, wherein the concentration of the poisoning cation in the second ion exchange bath is equal to the minimum concentration, and wherein the step of replacing the first ion exchange bath with a first replacement ion exchange bath comprises replacing the first ion exchange bath with the second ion exchange bath.

9. The method of claim 1, wherein the second replacement ion exchange bath is substantially free of poisoning cations.

10. The method of claim 1, wherein the first ion exchange bath is at a first temperature during ion exchange, and the second ion exchange bath is at a second temperature during ion exchange, wherein the first temperature is different from the second temperature.

11. The method of claim 10, wherein the first temperature and the second temperature are each in a range from about 380° C. to about 460° C.

12. The method of claim 11, wherein the second temperature is from about 5° C. to about 40° C. greater than the first temperature.

13. The method of claim 1, wherein the plurality of glass articles comprise an alkali aluminosilicate glass.

14. A method of ion exchanging a plurality of glass articles, the method comprising:
a. carrying out a first ion exchange step by immersing a first portion of the glass articles in a first ion exchange bath at a first temperature, the ion exchange bath comprising a concentration of a first cation and a concentration of a poisoning cation, wherein the concentration of the first cation is greater than the concentration of the poisoning cation, and wherein the concentration of the poisoning cation is less than or equal to a first concentration x and greater than or equal to a second concentration y;
b. carrying out a second ion exchange step after the first ion exchange step by immersing the glass articles in a second ion exchange bath at a second temperature, the second ion exchange bath comprising the first cation and the poisoning cation, wherein the poisoning cation is present in a concentration that is less than or equal to the second concentration y;
c. substituting the second ion exchange bath for the first ion exchange bath in the first ion exchange step when the concentration of the poisoning cation in the first ion exchange bath is equal to the first concentration;
d. ion exchanging a second portion of the plurality of glass articles in the second ion exchange bath at a third temperature after substituting the second ion exchange bath for the first ion exchange bath;
e. substituting the third ion exchange bath for the second ion exchange bath in the second ion exchange step when the concentration of the poisoning cation in the second ion exchange bath is greater than or equal to the second concentration y, wherein the third ion exchange bath is at a fourth temperature, comprises the first cation and is substantially free of the poisoning cation; and
f. ion exchanging the second portion in the third ion exchange bath at a fourth temperature after substituting the third ion exchange bath for the second ion exchange bath.

15. The method of claim 14, wherein substituting the second ion exchange bath for the first ion exchange bath in the first ion exchange step further comprises substituting the second ion exchange bath for the first ion exchange bath the concentration of the poisoning cation in the second ion exchange bath is greater than or equal to a second concentration y.

16. The method of claim 14, wherein each of the ion exchanged plurality of glass articles has a compressive layer in a range from about 700 MPa up to about 900 MPa, the compressive layer extending from a surface to a depth of layer.

17. The method of claim 14, wherein the minimum concentration of the poisoning cation is about 4 wt %.

18. The method of claim 14, wherein the maximum concentration of the poisoning cation is about 6 wt %.

19. The method of claim 14, wherein each of the first ion exchange bath, second ion exchange bath and third ion exchange bath comprises a first cation, the first cation being larger that the poisoning cation and present in a concentration that is greater than the concentration of the poisoning cation.

20. The method of claim 19, wherein the first cation and second cation are alkali cations.

21. The method of claim 20, wherein the first cation is K⁺ and the second cation is Na⁺.

22. The method of claim 14, wherein the first temperature and the second temperature are each in a range from about 380° C. to about 460° C.

23. The method of claim 14, wherein the first temperature is different from the second temperature.

24. The method of claim 23, wherein the second temperature is from about 5° C. to about 40° C. greater than the first temperature.

25. The method of claim 14, wherein the third temperature is different from the fourth temperature.

26. The method of claim 24, wherein the fourth temperature is at least about 5° C. to about 40° C. greater than the third temperature.

27. The method of claim 14, wherein the plurality of glass articles comprises an alkali aluminosilicate glass.
